(19) United States
(12) Patent Application Publication
(10) Pub. No.: US 2009/0074084 A1
(43) Pub. Date: Mar. 19, 2009

(54) Method and System for Adaptive Preprocessing for Video Encoder

(76) Inventors: David Drezner, Raanana (IL); Vadim Novikov, Netanya (IL)

Correspondence Address: MCANDREWS HELD & MALLOY, LTD, 500 WEST MADISON STREET, SUITE 3400, CHICAGO, IL, 60661, US

(21) Appl. No.: 11/933,877

(22) Filed: Nov. 1, 2007

Related U.S. Application Data
(60) Provisional application No. 60/973,344, filed on Sep. 18, 2007.

(51) Int. Cl. H04N 11/02

(52) U.S. Cl. 375/240.29; 375/E07.076

(57) ABSTRACT

Certain aspects of a method and system for adaptive preprocessing for an encoder may comprise filtering received video data using one or more spatial and/or temporal filtering parameters. The spatial and/or temporal filtering parameters may be adaptively updated to achieve a targeted bitrate based on statistical analysis of received video data and encoder feedback. The statistical analysis of received video data may comprise analysis of statistical inputs such as an encoding standard of the received video data, an average quantization factor, an input noise level, an average picture luma level, a motion vectors histogram, and a content type detection of the received video data. The spatial filtering parameters may be adaptively updated during an I frame of the received video data and the temporal filtering parameters may be adaptively updated per frame of the received video data.

### CROSS-REFERENCE TO RELATED APPLICATIONS/INCORPORATION BY REFERENCE

This application makes reference to, claims priority to, and claims benefit of U.S. Provisional Application Ser. No. 60/973,344 (Attorney Docket No. 18168US01) filed on Sep. 18, 2007.

This application also makes reference to:

U.S. application Ser. No. 11/313,592 (Attorney Docket No. 16903US01) filed Dec. 20, 2005; and
U.S. application Ser. No. 11/768,000 (Attorney Docket No. 18171US01) filed on Jun. 25, 2007.

Each of the above stated applications is hereby incorporated by reference in its entirety.

### FIELD OF THE INVENTION

Certain embodiments of the invention relate to processing of video signals. More specifically, certain embodiments of the invention relate to a method and system for adaptive preprocessing for a video encoder.

### BACKGROUND OF THE INVENTION

Analog video may be received through broadcast, cable, and VCRs. The reception is often corrupted by noise, and therefore to improve the visual quality, noise reduction may be needed. Digital video may be received through broadcast, cable, satellite, Internet, and video discs. Digital video may be corrupted by noise, which may include coding artifacts, and to improve the visual quality and coding gain, noise reduction may be beneficial. Various noise filters have been utilized in video communication systems such as set top boxes. However, inaccurate noise characterization, especially during scenes with motion, may result in artifacts caused by the filtering, which are more visually detrimental than the original noise.

In video system applications, random noise present in video signals, such as NTSC or PAL analog signals, for example, may result in images that are less than visually pleasing to the viewer and the temporal noise may reduce the video encoder coding efficiency. As a result, the temporal noise may affect the video quality of the encoded video stream with a given target bitrate. To address this problem, spatial and temporal noise reduction (NR) operations may be utilized to remove or mitigate the noise present. Traditional NR operations may use either infinite impulse response (IIR) filtering based methods or finite impulse response (FIR) filtering based methods. Temporal filtering may be utilized to significantly attenuate temporal noise. However, temporal filtering may result in visual artifacts such as motion trails, jittering, and/or wobbling at places where there is object motion when the amount of filtering is not sufficiently conservative. Spatial filtering may attenuate significantly high frequency noise or some narrow pass disturbing signals. However, spatial filtering may also attenuate the content spectrum, which may introduce blurriness artifacts in the active spatial filter areas.

Further limitations and disadvantages of conventional and traditional approaches will become apparent to one of skill in the art, through comparison of such systems with some aspects of the present invention as set forth in the remainder of the present application with reference to the drawings.

### BRIEF SUMMARY OF THE INVENTION

A system and/or method is provided for adaptive preprocessing for a video encoder, substantially as shown in and/or described in connection with at least one of the figures, as set forth more completely in the claims.

These and other features and advantages of the present invention may be appreciated from a review of the following detailed description of the present invention, along with the accompanying figures in which like reference numerals refer to like parts throughout.

### BRIEF DESCRIPTION OF SEVERAL VIEWS OF THE DRAWINGS

FIG. 1A is a block diagram of an exemplary video noise reduction system, in accordance with an embodiment of the invention.

FIG. 1B is an exemplary diagram of an MPEG like intra coding scheme, which may be utilized in connection with an embodiment of the invention.

FIG. 1C is an exemplary diagram of an MPEG like inter coding scheme, which may be utilized in connection with an embodiment of the invention.

FIG. 1D is an exemplary block diagram for coding frames using advanced video coding (AVC), which may be utilized in connection with an embodiment of the invention.

FIG. 2 is an exemplary flow diagram for determining whether video data is interlaced or progressive, in accordance with an embodiment of the invention.

FIG. 3 is a block diagram illustrating exemplary adaptive preprocessing of spatial and temporal filters for a video encoder, in accordance with an embodiment of the invention.

FIG. 4 is a flowchart illustrating exemplary steps for adaptive preprocessing of spatial and temporal filters for a video encoder, in accordance with an embodiment of the invention.

### DETAILED DESCRIPTION OF THE INVENTION

Certain embodiments of the invention may be found in a system and/or method for adaptive preprocessing for a video encoder. Certain aspects of a method may comprise filtering received video data using one or more spatial and/or temporal filtering parameters. The spatial and/or temporal filtering parameters may be adaptively updated to achieve a targeted bitrate according to statistical analysis of received video data and the encoder feedback.

The statistical analysis performed in the filter handler may comprise received video data such as a noise level, an average picture luma level, content type detection of the received video data, for example, interlace or progressive source and target encoder parameters such as target encoding standard, target encoding bitrate, for example, average and peak, buffer constrains, target frames per second and encoder feedback such as an average quantization factor and a motion vectors histogram. The spatial filtering parameters may be adaptively updated during an I frame of the received video data, and the temporal filtering may be adaptively updated per frame.

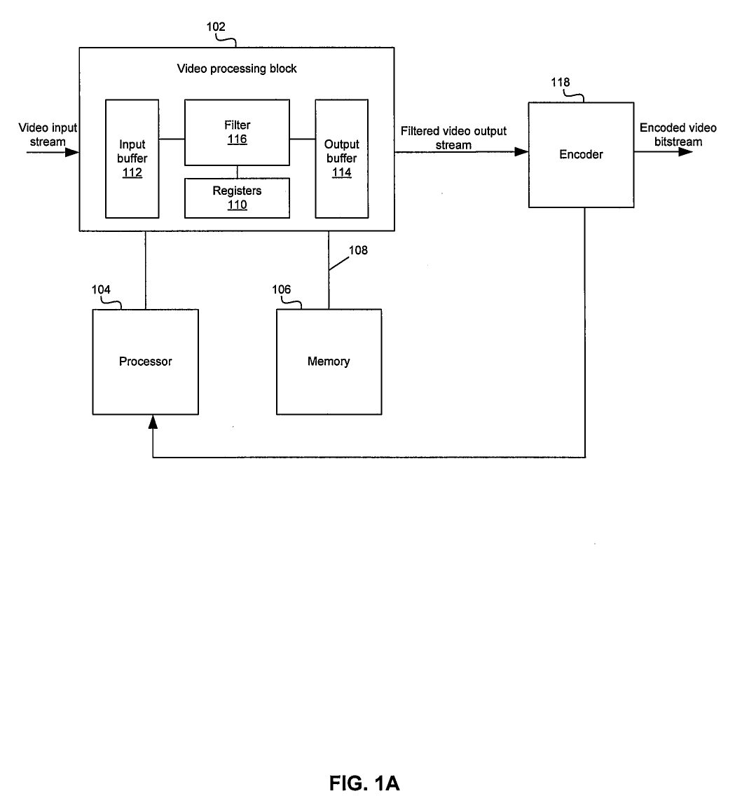

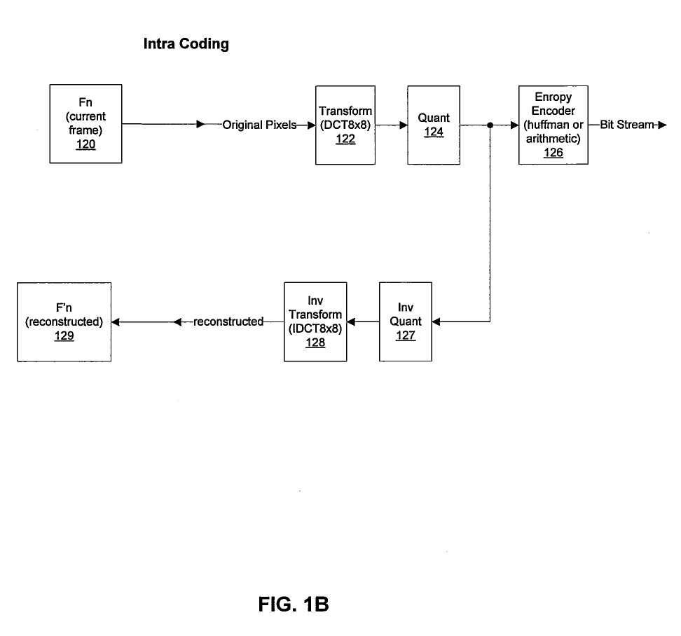

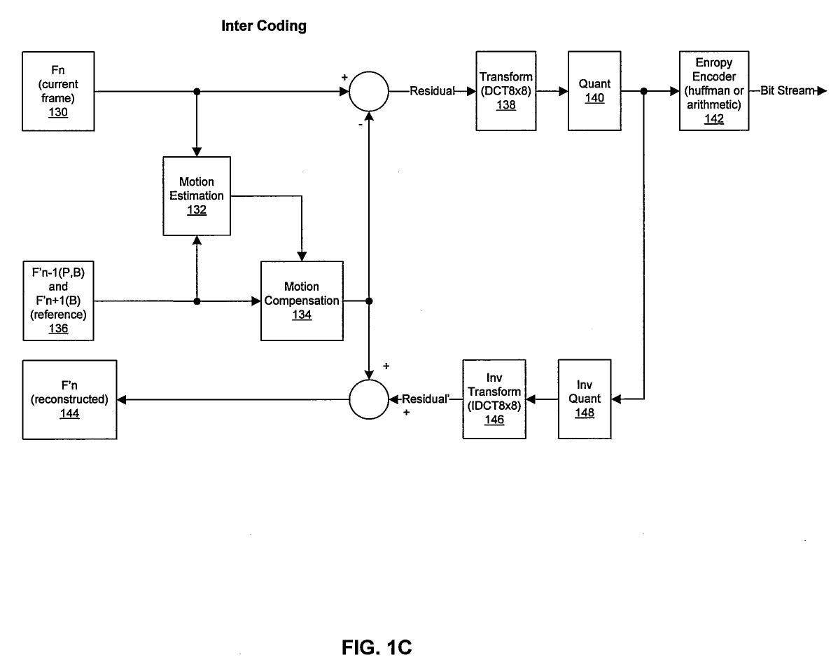

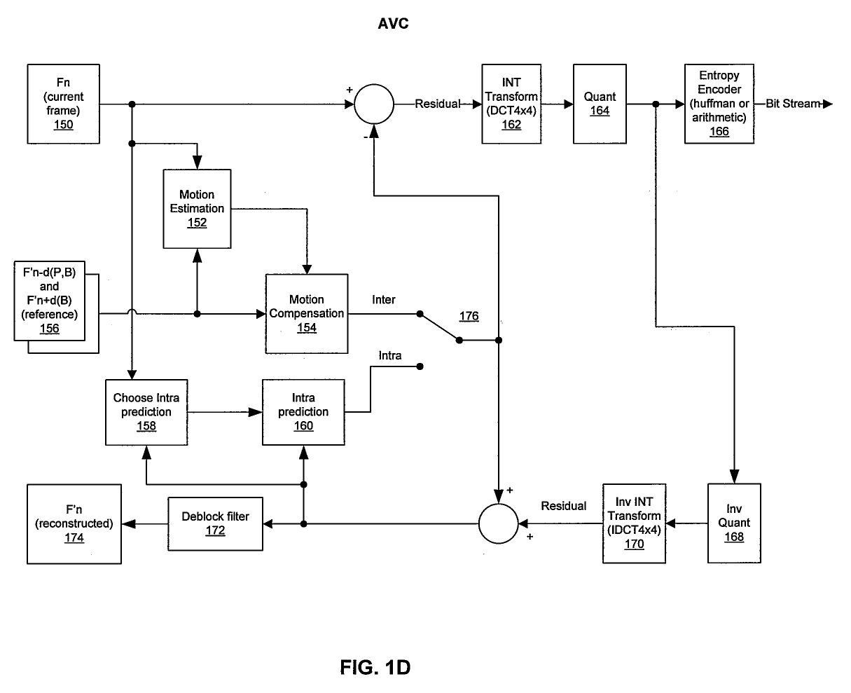

FIG. 1A is a block diagram of an exemplary video noise reduction system, in accordance with an embodiment of the invention. Referring to FIG. 1A, there is shown a video processing block 102, a processor 104, a memory 106, an encoder 118 and a data/control bus 108. The video processing block 102 may comprise registers 110 and filter 116. In some instances, the video processing block 102 may also comprise an input buffer 112 and/or an output buffer 114. The video processing block 102 may comprise suitable logic, circuitry, and/or code that may be enabled to filter pixels in a video picture or a video picture from a video input stream to reduce noise. For example, video frame pictures may be utilized in video systems with progressive video signals while video field pictures may be utilized in video systems with interlaced video signals. Video fields may alternate parity between top fields and bottom fields. A top field and a bottom field in an interlaced system may be deinterlaced or combined to produce a video frame.

The video processing block 102 may be enabled to receive a video input stream and, in some instances, to buffer at least a portion of the received video input stream in the input buffer 112. In this regard, the input buffer 112 may comprise suitable logic, circuitry, and/or code that may be enabled to store at least a portion of the received video input stream. Similarly, the video processing block 102 may be enabled to generate a filtered video output stream and, in some instances, to buffer at least a portion of the generated filtered video output stream in the output buffer 114. In this regard, the output buffer 114 may comprise suitable logic, circuitry, and/or code that may be enabled to store at least a portion of the filtered video output stream.

The filter 116 in the video processing block 102 may comprise suitable logic, circuitry, and/or code that may be enabled to perform an FIR filtering operation with noise reduction (FIR-NR) on the current pixel. In this regard, the filter 116 may be enabled to operate in a plurality of filtering modes, where each filtering mode may be associated with one of a plurality of supported filtering operations. The filter 116 may utilize video content, filter coefficients, threshold levels, and/or constants to generate the filtered video output stream in accordance with the filtering mode selected. In this regard, the video processing block 102 may generate blending factors to be utilized with the appropriate filtering mode selected. The registers 110 in the video processing block 102 may comprise suitable logic, circuitry, and/or code that may be enabled to store information that corresponds to filter coefficients, threshold levels, and/or constants, for example. Moreover, the registers 110 may be enabled to store information that corresponds to a selected filtering mode.

The processor 104 may comprise suitable logic, circuitry, and/or code that may be enabled to process data and/or perform system control operations. The processor 104 may be enabled to control at least a portion of the operations of the video processing block 102. For example, the processor 104 may generate at least one signal to control the selection of the filtering mode in the video processing block 102. Moreover, the processor 104 may be enabled to program, update, and/or modify filter coefficients, threshold levels, and/or constants in at least a portion of the registers 110. For example, the processor 104 may generate at least one signal to retrieve stored filter coefficients, threshold levels, and/or constants that may be stored in the memory 106 and transfer the retrieved information to the registers 110 via the data/control bus 108.

The memory 106 may comprise suitable logic, circuitry, and/or code that may be enabled to store information that may be utilized by the video processing block 102 to reduce noise in the video input stream. The processor 104 may also be enabled to determine noise levels for a current video picture based on an early-exit algorithm (EEA) or an interpolation estimate algorithm (IEA), for example. The memory 106 may be enabled to store filter coefficients, threshold levels, and/or constants, for example, to be utilized by the video processing block 102. U.S. application Ser. No. 11/313,592 (Attorney Docket No. 16903US01) filed Dec. 20, 2005, provides a detailed description of the early-exit algorithm (EEA) and the interpolation estimate algorithm (IEA), and is hereby incorporated by reference in its entirety.

The encoder 118 may be enabled to receive and process a plurality of statistical inputs from the processor 104 and the video processing block 102. The encoder 118 may be enabled to process the plurality of statistical inputs by reading a statistics function, for example, a ReadStatistics function. The plurality of statistical inputs received from the processor 104 and the video processing block 102 may comprise one or more of an average luma scalar value, a still content detection flag, and a noise level of video data in dB, for example and feedback the analyzed statistics inputs to the processor 104. The encoder 118 may be enabled to generate the encoded video bitstream based on encoding the filtered video output stream.

In operation, the processor 104 may select a filtering mode of operation and may program the selected filtering mode into the registers 110 in the video processing block 102. Moreover, the processor 104 may program the appropriate values for the filter coefficients, threshold levels, and/or constants into the registers 110 in accordance with the selected filtering mode. The video processing block 102 may receive the video input stream and may filter pixels in a video picture in accordance with the selected filtering mode. In some instances, the video input stream may be stored in the input buffer 112 before processing. The video processing block 102 may generate the appropriate blending factors needed to perform the noise reduction filtering operation selected by the processor 104. The video processing block 102 may generate the filtered video output stream after performing the noise reduction filtering operation. In some instances, the filtered video output stream may be stored in the output buffer 114 before being transferred out of the video processing block 102.

The processor 104 may determine the mode of operation of various portions of the video processing block 102. For example, the processor 104 may configure data registers in the video processing block 102 to allow direct memory access (DMA) transfers of video data to the memory 106. The processor 104 may also communicate instructions to an image sensor to initiate capturing of images. The memory 106 may be used to store image data that may be processed and communicated by the processor 104. The memory 106 may also be used for storing code and/or data that may be used by the processor 104. The memory 106 may also be used to store data for other functionalities of the video processing block 102. For example, the memory 106 may store data corresponding to voice communication. The processor 104 may comprise a state machine that may enable determination of whether video data type is interlaced type or progressive type.

In accordance with an embodiment of the invention, an MPEG like video encoder such as MPEG2 or MPEG4-AVC, may follow the filtered video output stream and provide feedback to the processor 104. An embodiment of the invention may comprise a MPEG like encoder that may be enabled to select intra coding per macroblock (MB) to remove spatial redundancies or inter coding per MB to remove both spatial and temporal redundancies.

FIG. 1B is an exemplary diagram of an MPEG like intra coding scheme, which may be utilized in connection with an embodiment of the invention. Referring to FIG. 1B, there is shown buffers 120 and 129, a DCT transform block 122, a quantizer block 124, an entropy encoder block 126, an inverse quantizer block 127, and an inverse transform block 128. The buffer 120 may hold original pixels of a current picture and the DCT transform block 122 may perform DCT transform of the original pixels. The DCT transform block 122 may generate DCT coefficients, which may be communicated to the quantizer block 124. The quantized coefficients generated by the quantizer block 124 may then be scanned using zig-zag or alternate scan by the entropy encoder block 126.

The quantized coefficients from the quantizer block 124 may be processed by the inverse quantizer block 127, then processed by the inverse DCT transform block 128 to reconstruct pixels from the original frame. The reconstructed pixels from the inverse transform block 128 may be stored, for example, in the buffer 129. The reconstructed pixels may be used, for example, for processing subsequent video frames.

FIG. 1C is an exemplary diagram of an MPEG like inter coding scheme, which may be utilized in connection with an embodiment of the invention. Referring to FIG. 1C, there is shown buffers 130, 136, and 144, a motion estimation block 132, a motion compensation block 134, a DCT transform block 138, a quantizer block 140, an entropy encoder block 142, an inverse quantizer block 148, and an inverse transform block 146.

The buffer 130 may hold the original pixels of the current frame and the buffer 136 may hold reconstructed pixels of previous frames. An encoding method from, for example, MPEG standard, may use the motion estimation block 132 to process a block of 16×16 pixels in the buffer 130 and a corresponding block of pixels and to find a motion vector for the block of 16×16 pixels. The motion vector may be communicated to the motion compensation block 134, which may use the motion vector to generate a motion compensated block of 16×16 pixels from the reconstructed pixels stored in the buffer 136. The motion compensated block of 16×16 pixels may be subtracted from the original pixels from the buffer 130, and the result may be referred to as residual pixels.

The residual pixels may be DCT transformed by DCT transform block 138, and the resulting DCT coefficients may be quantized by the quantizer block 140. The quantized coefficients from the quantizer block 140 may be communicated to the entropy encoder 142 and the inverse quantizer block 148. The entropy encoder block 142 may scan the quantized coefficients in zig-zag scan order or alternate scan order.

The quantized coefficients may be processed by the inverse quantizer block 148 and then by the inverse DCT transform block 146 to generate reconstructed residual pixels. The reconstructed residual pixels may then be added to the motion compensated block of 16×16 pixels from the motion compensation block 134 to generate reconstructed pixels, which may be stored in the buffer 144. The reconstructed pixels may be used, for example, to process subsequent video frames. In another embodiment of the invention, intra coding mode maybe utilized for processing I-frames.

FIG. 1D is an exemplary block diagram for coding frames using advanced video coding (AVC), which may be utilized in connection with an embodiment of the invention. Referring to FIG. 1D, there is shown buffers 150, 156, and 174, a motion estimation block 152, a motion compensation block 154, an INTRA selection block 158, an INTRA prediction block 160, an integer approximation of DCT (INT) transform block 162, a quantizer block 164, an entropy encoder block 166, an inverse quantizer block 168, an inverse INT transform block 170, and a deblock filter 172. There is also shown a switch 176 that may enable selection of pixels from the motion compensation block 154 or the INTRA prediction block 160, depending on whether an INTER MB or an INTRA MB is being encoded. The switch 176 may comprise, for example, a multiplexer functionality.

The buffer 150 may hold the original pixels of the current frame and the buffer 156 may hold reconstructed pixels of previous frames. An encoding method from, for example, MPEG standard, may use the motion estimation block 152 to process a macroblock of 16×16 pixels in the buffer 150 and a corresponding block of pixels from, for example, one or two previously reconstructed frames, to find a motion vector for the macroblock of 16×16 pixels. The motion vector may be communicated to the motion compensation block 154, which may use the motion vector to generate a motion compensated macroblock of 16×16 pixels from the reconstructed pixels stored in the buffer 156. These pixels may be selected, for example, when an INTER frame is being encoded using AVC.

The INTRA selection block 158 may receive pixels from the buffer 150 and the presently reconstructed pixels where the reconstructed pixels may be the pixels from the switch 176 added to the pixels from the inverse INT transform block 170. Based on the input pixels, the INTRA selection block 158 may select an appropriate INTRA prediction mode and communicate the selected INTRA prediction mode to the INTRA prediction block 160. The INTRA prediction block 160 may also receive presently reconstructed pixels where the reconstructed pixels may be the pixels from the switch 176 added to the pixels from the inverse DCT transform block 170. The INTRA prediction block 160 may generate output pixels based on the selected INTRA prediction mode and the reconstructed pixels to the switch 176. These pixels may be selected, for example, when an INTRA frame is being encoded using AVC.

The selected pixels from the switch 176 may be subtracted from the original pixels from the buffer 150, and the result may be referred to as residual pixels. The residual pixels may be INT transformed by INT transform block 162, where the integer (INT) transform may operate on 4×4 pixel blocks. The INT transform is an approximation of the DCT base functions. The resulting INT coefficients may be quantized by the quantizer block 164. The quantized coefficients from the quantizer block 164 may be communicated to the entropy encoder 166 and the inverse quantizer block 168. The entropy encoder block 166 may scan the quantized coefficients in, for example, a zig-zag scan order.

The quantized coefficients may be processed by the inverse quantizer block 168 and then by the inverse INT transform block 170 to generate reconstructed residual pixels. The reconstructed residual pixels may then be added to the selected pixels from the switch 176 to generate reconstructed pixels. The reconstructed pixels may be processed by the deblock filter 172 to alleviate “blocky” artifacts that may result from compression. The output of the deblock filter 172 may be stored in the buffer 174. The reconstructed pixels may be used, for example, to process subsequent video frames.

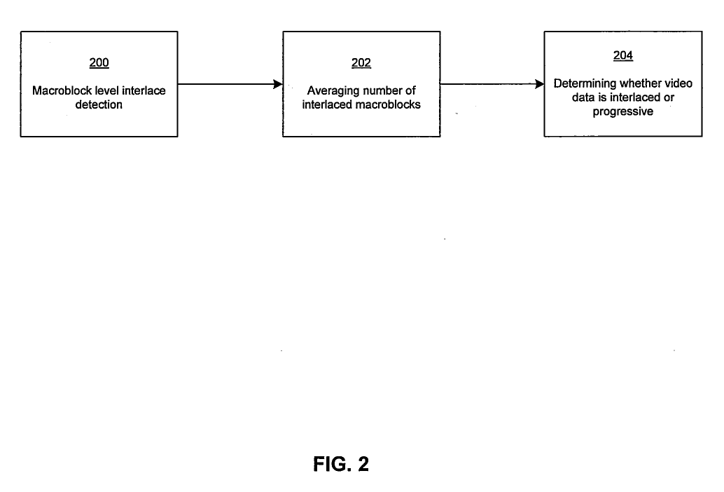

FIG. 2 is an exemplary flow diagram for determining whether video data is interlaced or progressive, in accordance with an embodiment of the invention. Referring to FIG. 2, there is shown steps 200 to 204. In the step 200, a determination may be made of whether each macroblock may be interlaced or progressive video data. The macroblock may comprise, for example, a block of 16 pixels by 16 pixels. Frame variance and field variance may be calculated for each macroblock using, for example, the original unencoded picture. A variance may indicate smoothness of a pixel area. Therefore, smaller variance may indicate that the pixel area may be smooth and that the pixels may be correlated. For example, in an interlaced movie, odd fields and even fields may be snapshots of an event at different instances of time. Therefore, each field may be smoother individually than when the two fields are combined. Therefore, an interlaced video data may have a smaller field variance than frame variance.

Accordingly, the field variance may be subtracted from the frame variance. If the difference is, for example, greater than a threshold value, the macroblock may be considered to be an interlaced macroblock. Otherwise, the macroblock may be considered to be a progressive macroblock.

In step 202, the result for each macroblock may be accumulated to determine whether a frame or a plurality of frames may be interlaced or progressive. This may be because the quantity of macroblocks in a frame may fluctuate due to noise. However, video data that may have been pulled-up may erroneously weight the number of interlaced macroblocks. For example, for 3-2 pull-up, the two frames that have been pulled-up may comprise pull-up artifacts. A frame with pull-up artifacts may comprise a large number of interlaced macroblocks although the frame may be progressive. This may bias the determination of whether the video data is progressive type or interlaced type.

A pull-up detector may be used before the progressive/interlace detector and therefore the pulled-up content may be pulled-down and detected as progressive content. However, the pull-up detector may have some mismatches for a short time and bias the decision of the progressive/interlace detector. In order to alleviate the effects of these mismatches, the exemplary algorithm illustrated in FIG. 2 may be used.

Accordingly, an embodiment of the invention may use an algorithm where one frame from a cluster of, for example, 4 frames may be used to determine the number of interlaced macroblocks. For example, the number of interlaced macroblocks from each frame in the cluster may be compared, and the smallest number of interlaced macroblocks may be selected. The selected number of interlaced macroblocks may then be added to a running sum for, for example, 15 clusters or a macrocluster. The running sum may be cleared to zero at the end of the 15th cluster. Therefore, a running sum of interlaced macroblocks may be generated every 60 frames to determine whether the video data may be interlaced or progressive.

In step 204, the running sum may be compared to a progressive threshold and to an interlaced threshold, where the interlaced threshold may be a higher value than the interlaced threshold. The different values of the threshold may provide a hysteresis effect. If the running sum is lower than the progressive threshold, the video data may be considered to be progressive. Similarly, if the running sum is higher than the interlaced threshold, the video data may be considered to be interlaced. However, in order to reduce effects of noise on the video data, a plurality of consecutive running sums may need to be determined to be the same type of video data. For example, three consecutive running sums may need to indicate the same video data type before the video data is determined to be that video type.

When video data has been determined to be progressive type video data, an embodiment of the invention may also identify whether the video data may be top-field first cadence or bottom-field first cadence. By identifying the progressive cadence, the encoding of the video data may be more efficient. The identification of the progressive cadence may be by a method that may be design dependent.

Various embodiments of the invention may allow dynamic switching of scanning method from zig-zag scan to alternate scan, or vice-versa, depending on the video data. The processing described in the steps 300 to 304 may be accomplished by, for example, the processor 104, and/or other circuitry, such as, for example, the filter 116, which may be part of the video processing block 102.

In accordance with an embodiment, of the invention, when video data has been determined to be progressive type video data or interlaced type video data, a signal may be communicated to a temporal and/or spatial filter to update one or more temporal and/or spatial filtering parameters.

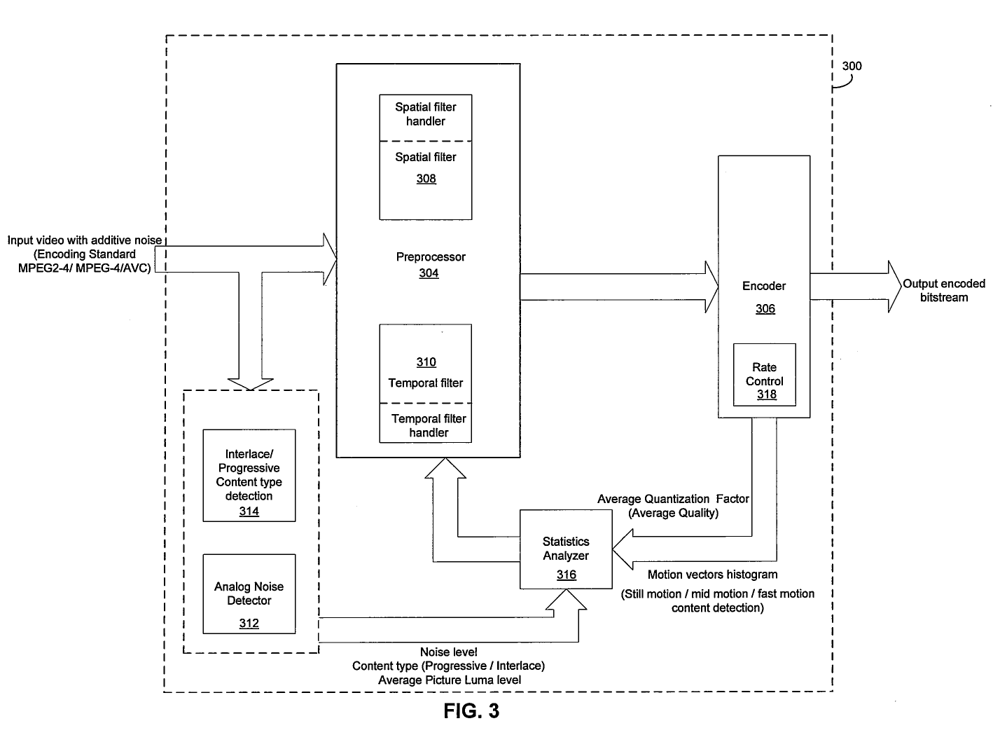

FIG. 3 is a block diagram illustrating exemplary adaptive preprocessing of spatial and temporal filters for an encoder, in accordance with an embodiment of the invention. Referring to FIG. 3, there is shown a video processing system 300. The video processing system 300 may comprise a preprocessor 304, an encoder 306, an analog noise detector 312 and a content type detection block 314. The preprocessor 304 may comprise a spatial filter 308 and a temporal filter 310. The encoder 306 may comprise a rate control module 318.

The spatial filter 308 may comprise suitable logic, circuitry and/or code that may be enabled to control the amount of blurriness, for example, and may indirectly affect the blockiness and ringing artifacts generated by the encoder 306. The blockiness artifact may be caused by distorting the distribution or spectrum of the block transform domain by a quantizer. The blockiness artifact may be related to a lower spectrum coefficient or frequency distortion by the quantization. The blockiness artifact may be visible on the block boundaries, for example, 8×8 pixels for MPEG 1, 2, 4 and both 4×4 pixels and 8×8 pixels for MPEG4 part 10 AVC, for example. The blockiness artifact may be perceived in flat texture areas in a given picture or video, for example.

The ringing encoding artifact may be also referred to as a mosquito artifact and may be caused by distorting the distribution and/or spectrum of the block transform domain, by a quantizer. The ringing encoding artifact may be related to a higher spectrum coefficient or frequency distortion by the quantization. The ringing encoding artifact may be visible on edges or text boundaries with a flat texture area, for example.

The spatial filter 308 may be enabled to manage a tradeoff between blurriness, blockiness, and ringing artifacts, for example. In accordance with an embodiment of the invention, the spatial filter 308 may be enabled to increase the blurriness artifacts and simultaneously reduce the blockiness and ringing artifacts. In accordance with another embodiment of the invention, the spatial filter 308 may be enabled to reduce the blurriness artifacts and simultaneously increase the blockiness and ringing artifacts. When the blurriness artifact on the encoder 306 input is increased, there may be a higher spatial correlation, which may lead to more concentrated transformed domain coefficients both in Intra coding and in residual Inter coding. The higher spatial correlation may lead to a lower entropy and a lower bitrate or the higher spatial correlation may lead to a finer encoding quantizer or reduction in blockiness and ringing encoding artifacts for a given target bitrate. The spatial filter 308 may be enabled to receive one or more statistical inputs from the statistics analyzer 316. The spatial filter 308 may receive the encoding standard of the input video stream, for example, MPEG2/4 or MPEG4-AVC. The spatial filter 308 may receive the average quantization factor from the encoder 306. The spatial filter 308 may receive the input noise level in dB, for example, and the average picture luma level from the statistics analyzer 316.

The spatial filter 308 may comprise a spatial filter handler function that may be enabled to set one or more filtering coefficients in the spatial filter 308. In one embodiment of the invention, the spatial filter 308 may be enabled to update the filtering parameters during I pictures, for example. In another embodiment of the invention, the spatial filter 308 may avoid changing filtering parameters in the middle of a group of pictures (GOP) in order to prevent temporal changes inside the GOP. The spatial filter handler 308 may be enabled to update the filtering parameters smoothly in order to avoid perceptual blurriness visible changes. The spatial filter handling function may set a current filtering cutoff parameter and a target filtering cutoff parameter as inputs from the statistics analyzer 316 and a delta filter value.

The temporal filter 310 may comprise a temporal filter handler function that may be enabled to control and/or set one or more filtering coefficients in the temporal filter 310, which may control the additive noise level reduction which may be passed to the encoder 306 and may indirectly affect the blockiness and ringing artifacts generated by the encoder 306. The temporal filter handler 310 may be enabled to manage a tradeoff between additive noise level, blockiness, and ringing artifacts, for example. In accordance with an embodiment of the invention, the temporal filter 310 may be enabled to increase the suppression of additive noise and simultaneously reduce the blockiness and ringing artifacts. In accordance with another embodiment of the invention, the temporal filter 310 may be enabled to reduce the suppression of additive noise and simultaneously increase the blockiness and ringing artifacts. When the temporal noise level is reduced on the encoder 306 input, there may be a higher temporal correlation, which may lead to more concentrated residual transformed domain for inter coding coefficients. The higher temporal correlation may lead to a lower entropy and a lower bitrate. The temporal filter 310 may be enabled to utilize finer encoding quantizers to achieve a target bitrate, for example, and the finer quantizers may achieve reduction in blockiness and ringing artifacts.

The temporal filter 310 may be enabled to receive one or more statistical inputs from the statistics analyzer 316. The temporal filter 310 may receive the input noise level in dB, for example. The temporal filter 310 may receive the motion vectors histogram from the encoder 306. The motion vectors histogram may provide a sliding scale based on the motion of the received input video data. The motion vectors histogram may be divided into one or more categories, for example, extremely high motion content, high motion content, mid motion content, low motion content, or still motion content. Other categories may be utilized without departing from the various aspects and scope of the invention. Notwithstanding, the temporal filter 310 may receive a signal from the content type detection block 314 that may indicate whether the received input video data is interlaced video data or progressive video data, for example. In accordance with an embodiment of the invention, the plurality of statistical inputs received from the statistic analyzer 316 and the encoder 306 may be updated per picture or number of pictures, for example.

The temporal filter 310 may comprise a temporal filter handler function that may be enabled to receive one or more statistical inputs, for example, the input noise level of video data from the statistics analyzer 316, a motion vectors histogram from the encoder 306, and an interlace video data or progressive video data from the content type detection block 314. The temporal filter handler may be enabled to set the temporal filtering strength of the temporal filter 310 in the preprocessor 304 based on the received statistical inputs. The temporal filter strength may be directly proportional to the input noise level of video data. The amount of temporal filtering may be reduced in high motion content video data or medium motion content video data in order to reduce the temporal trailing and/or ghosting artifacts. In another embodiment of the invention, the temporal filter 310 may be tuned depending on whether the received video data is interlaced video data or progressive video data. In another embodiment of the invention, the temporal filter 310 may be tuned depending on the target bitrate and average quality level received from the statistical analyzer.

The analog noise detector (AND) 312 may comprise suitable logic, circuitry and/or code that may be enabled to estimate the level of noise that may be distributed in the received video data. The AND 312 may be coupled to the temporal filter 310 via a temporal noise reduction algorithm to reduce the noise effectively. The AND 312 may be enabled to estimate the level of noise that may be approximately Gaussian distributed in the video data. The noise in the video data may be assumed to be independent and identically distributed (IID), for example, in different pictures of the video data for a certain period of time. The temporal filter strength may be directly proportional to the input noise level of video data. For example, in noiseless video, the temporal filtering may be turned OFF in order to avoid temporal trailing and/or ghosting artifacts.

The content type detection block 314 may comprise suitable logic, circuitry and/or code that may be enabled to determine whether the received video data is interlaced video data or progressive video data. U.S. application Ser. No. 11/768,000 (Attorney Docket No. 18171US01) filed on Jun. 25, 2007, discloses a method for determining whether the received video data is interlaced video data or progressive video data, and is hereby incorporated by reference in its entirety.

In operation, a user may be enabled to initialize the preprocessor 304 by selecting a filter startup condition function, for example, an init_state function. The user may be enabled to set one or more of the following parameters in the preprocessor 304, for example, a UseAdaptiveControl parameter and a VideoBitRate parameter during initialization of the preprocessor 304. The UseAdaptiveControl parameter may indicate a particular filter adaptive control algorithm to be utilized by the preprocessor 304. The VideoBitRate parameter may indicate the target bit rate to be achieved by an encoder rate control (RC) module 318 within the encoder 306 and the spatial filter handler 308 may be enabled to modify the filtering parameters with respect to the target bitrate encoder setting. In another embodiment of the invention, the bitrate bouncing effect between the spatial filter and encoder RC module may be prevented. In accordance with an embodiment of the invention, the preprocessor 304 may be enabled to process a filter handling algorithm that may be utilized for achieving higher compression gain by the encoder 306.

The encoder 306 may be enabled to receive and process a plurality of statistical inputs from the preprocessor 304. The encoder 306 may be enabled to process the plurality of statistical inputs by reading a statistics function, for example, a ReadStatistics function. The plurality of statistical inputs received from the preprocessor 304 may comprise one or more of an average luma scalar value, a still content detection flag, and a noise level of video data in dB, for example.

The statistics analyzer 316 may be enabled to perform statistical analysis of received data comprising a plurality of statistical inputs received from the encoder 306 utilizing a function, for example, an AnalyzeStatistics function. The statistics analyzer 316 may be enabled to transfer one or more of the statistical parameters received from the encoder 306 to the spatial filter handler 308 and/or the temporal filter handler 310 as a function of one or more of the following statistical parameters, for example, average quality of video data and average motion scale, for example, still motion, medium motion or fast motion.

The statistics analyzer 316 may be enabled to transfer the required target filtering based on the target bit rate to the filter handler function in the spatial filter 308 and/or the temporal filter 310. The statistics analyzer 316 may be enabled to prevent bouncing artifacts with the rate control module 318 of the encoder 306. The filtering parameters may be changed slowly compared to quantization changes in order to prevent the bouncing artifacts. The statistics analyzer 316 may be enabled to apply a hysteresis function on the input average quality of the video data.

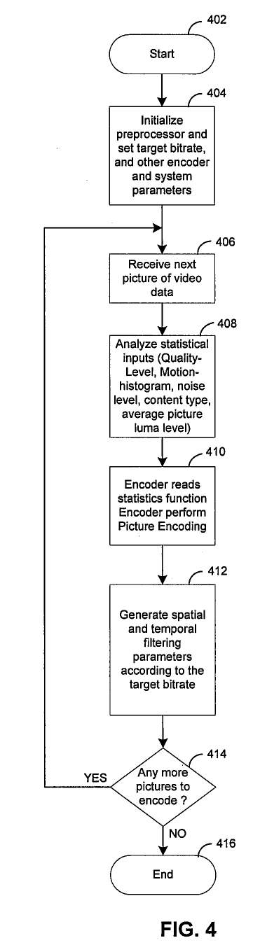

FIG. 4 is a flowchart illustrating exemplary steps for adaptive preprocessing of spatial and temporal filters for an encoder, in accordance with an embodiment of the invention. Referring to FIG. 4, control begins at step 402. In step 404, the preprocessor 304 may be initialized by selecting a filter startup condition function, for example, an init_state function. The user may be enabled to set one or more of the following parameters in the preprocessor 304, for example, a particular filter adaptive control algorithm to be utilized by the preprocessor 304 and the target bit rate to be achieved by the encoder RC module 318 in the encoder 306. The spatial filter 308 and/or the temporal filter 310 setting may be affected by the target bit rate setting. The encoder 306 and other system parameters may be initialized.

In step 406, the preprocessor 304 may receive video data and determine the encoding standard of the video data, for example, MPEG2, MPEG4 or MPEG4-AVC. The preprocessor 304 may receive a signal from the content type detection block 314 indicating type of received video data, for example, interlaced type or progressive type 2:2 pull-up source or 3:2 pull-up source.

In step 408, the statistics analyzer 316 may be enabled to analyze a plurality of statistical inputs received by feedback from the encoder 306. For example, the statistics analyzer 316 may be enabled to analyze the average quality of video data or average quantization factor and the motion vectors histogram of the received video data indicating the motion, for example, low motion, medium motion or high motion of video data, noise level of received video data, content type of received video data, for example, progressive or interlaced and average picture luma level of received video data. In step 410, the encoder 306 may be enabled to read a statistical function that may comprise statistical analysis of one or more statistical inputs, for example, an average luma scalar value, content type of video data, for example, progressive or interlaced, and/or a noise level of video data. The encoder 306 may be enabled to adaptively modify the encoding process or rate control based on one or more of the statistical inputs and perform picture encoding of the received video data.

In step 412, the statistics analyzer 316 may be enabled to generate spatial and temporal filtering parameters, for example, a current filtering cutoff parameter and a target filtering cutoff parameter based on target bit rate. The target filtering cutoff parameter may affect the targeted bitrate to be achieved by the encoder rate control module 318 in the encoder 306. In another embodiment of the invention, an anti-bouncing function may be utilized to control the filtering. The preprocessor 304 may be enabled to adaptively update the filtering parameters of the spatial filter 308 and the temporal filter 310 based on analyzing the statistical inputs corresponding to the received video data. In step 414, it may be determined whether any more pictures need to be encoded. If there more pictures to be encoded, control returns to step 406. If there are no more pictures to be encoded, control passes to end step 416.

In accordance with an embodiment of the invention, a method and system for adaptive preprocessing for an encoder may comprise a spatial filter 308 for filtering received video data using one or more spatial filtering parameters and a temporal filter 310 for filtering received video data using one or more temporal filtering parameters. The preprocessor 304 may be enabled to adaptively update the spatial and/or temporal filtering parameters to achieve a targeted bitrate based on statistical analysis of received video data and encoder feedback. The statistical analysis of received video data may comprise analysis of inputs such as an encoding standard for example, MPEG2, MPEG4 or MPEG4-AVC and analysis of received video data such as an input noise level, an average picture luma level and a content type detection of the received video data, and encoder feedback such as an average quantization factor and a motion vectors histogram.

The spatial filtering parameters may comprise one or more of a current filtering cutoff parameter and a target filtering cutoff parameter and a temporal filtering blending parameter. The target filtering cutoff parameter and/or temporal filtering blending parameter may affect the target bitrate to be achieved so that the changes in filtering cutoff and blending may be slower than the encoder rate-control (RC) module 318 and other quantizer parameters to achieve the target bitrate. The target filtering cutoff parameter may provide an indication of the target bitrate to be achieved.

The motion vectors histogram may categorize the received video data into one or more categories, for example, extremely high motion content, high motion content, mid motion content, low motion content, and still motion content. The content type detection block 314 may be enabled to detect the type of content of the received video data to be one of interlaced type or progressive type. The preprocessor 304 may be enabled to adaptively update spatial filtering parameters during an I frame of the received video data. The preprocessor 304 may be enabled to adaptively update temporal filtering parameters per frame of the received video data. The encoder 306 may be enabled to encode the received video data based on the adaptive updating of the plurality of filtering parameters.

Another embodiment of the invention may provide a machine-readable storage, having stored thereon, a computer program having at least one code section executable by a machine, thereby causing the machine to perform the steps as described above for adaptive preprocessing for a video encoder.

Accordingly, the present invention may be realized in hardware, software, or a combination thereof. The present invention may be realized in a centralized fashion in at least one computer system, or in a distributed fashion where different elements may be spread across several interconnected computer systems. Any kind of computer system or other apparatus adapted for carrying out the methods described herein may be suited. A typical combination of hardware and software may be a general-purpose computer system with a computer program that, when being loaded and executed, may control the computer system such that it carries out the methods described herein. The present invention may be realized in hardware that comprises a portion of an integrated circuit that also performs other functions.

The present invention may also be embedded in a computer program product, which comprises all the features enabling the implementation of the methods described herein, and which when loaded in a computer system is able to carry out these methods. Computer program in the present context means any expression, in any language, code or notation, of a set of instructions intended to cause a system having an information processing capability to perform a particular function either directly or after either or both of the following: a) conversion to another language, code or notation; b) reproduction in a different material form.

While the present invention has been described with reference to certain embodiments, it will be understood by those skilled in the art that various changes may be made and equivalents may be substituted without departing from the scope of the present invention. In addition, many modifications may be made to adapt a particular situation or material to the teachings of the present invention without departing from its scope. Therefore, it is intended that the present invention not be limited to the particular embodiment disclosed, but that the present invention will include all embodiments falling within the scope of the appended claims.

What is claimed is:

1. A method for processing video data, the method comprising:
filtering received video data using one or more filtering parameters; and
adaptively updating said one or more filtering parameters to achieve a targeted bitrate based on statistical analysis of said received video data.

2. The method according to claim 1, wherein said one or more filtering parameters comprises one or both of spatial filtering parameters and temporal filtering parameters.

3. The method according to claim 2, wherein said statistical analysis of said received video data comprises analysis of one or more of an input noise level of said received video data, a detected type of content of said received video data, an average picture luma level of said received video data, an encoding standard of said received video data, an average quantization factor and a motion vectors histogram.

4. The method according to claim 3, comprising feeding back said average quantization factor and said motion vectors histogram from an encoder.

5. The method according to claim 3, wherein said encoding standard of said received video data is one of MPEG2, MPEG4 or MPEG4-AVC.

6. The method according to claim 3, wherein said motion vectors histogram categorizes said received video data into one or more categories comprising extremely high motion content, high motion content, mid motion content, low motion content, and still motion content.

7. The method according to claim 3, wherein said detected type of said content of said received video data is one of interlaced type or progressive type.

8. The method according to claim 2, wherein said spatial filtering parameters comprises one or more of a current filtering cutoff parameter and a target filtering cutoff parameter.

9. The method according to claim 8, wherein said target filtering cutoff parameter provides an indication of said targeted bitrate.

10. The method according to claim 2, comprising adaptively updating said spatial filtering parameters during an I frame of said received video data.

11. The method according to claim 1, comprising encoding said received video data based on said adaptive updating of said one or more filtering parameters.

12. A system for processing video data, the system comprising:
one or more circuits that enables, at least:
filtering received video data using one or more filtering parameters; and
adaptively updating said filtering parameters to achieve a targeted bitrate based on statistical analysis of said received video data.

13. The system according to claim 12, wherein said one or more filtering parameters comprises one or both of spatial filtering parameters and temporal filtering parameters.

14. The system according to claim 13, wherein said statistical analysis of said received video data comprises analysis of one or more of an input noise level of said received video data, a detected type of content of said received video data, an average picture luma level of said received video data, an encoding standard of said received video data, an average quantization factor and a motion vectors histogram.

15. The system according to claim 14, wherein said one or more circuits enables feeding back of said average quantization factor and said motion vectors histogram from an encoder.

16. The system according to claim 14, wherein said encoding standard of said received video data is one of MPEG2, MPEG4 or MPEG4-AVC.

17. The system according to claim 14, wherein said motion vectors histogram categorizes said received video data into one or more categories comprising extremely high motion content, high motion content, mid motion content, low motion content, and still motion content.

18. The system according to claim 14, wherein said detected type of said content of said received video data is one of interlaced type or progressive type.

19. The system according to claim 13, wherein said spatial filtering parameters comprises one or more of a current filtering cutoff parameter and a target filtering cutoff parameter.

20. The system according to claim 19, wherein said target filtering cutoff parameter provides an indication of said targeted bitrate.

21. The system according to claim 13, wherein said one or more circuits enables adaptively updating said spatial filtering parameters during an I frame of said received video data.

22. The system according to claim 12, wherein said one or more circuits enables encoding of said received video data based on said adaptive updating of said one or more filtering parameters.

23. A machine-readable storage having stored thereon, a computer program having at least one code section for processing video data, the at least one code section being executable by a machine for causing the machine to perform steps comprising:
filtering received video data using one or more filtering parameters; and
adaptively updating said one or more filtering parameters to achieve a targeted bitrate based on statistical analysis of said received video data.

24. The machine-readable storage according to claim 23, wherein said one or more filtering parameters comprises one or both of spatial filtering parameters and temporal filtering parameters.

25. The machine-readable storage according to claim 24, wherein said statistical analysis of said received video data comprises analysis of one or more of an input noise level of said received video data, a detected type of content of said received video data, an average picture luma level of said received video data, an encoding standard of said received video data, an average quantization factor and a motion vectors histogram.

26. The machine-readable storage according to claim 25, wherein said at least one code section comprises code for feeding back said average quantization factor and said motion vectors histogram from an encoder.

27. The machine-readable storage according to claim 25, wherein said encoding standard of said received video data is one of MPEG2, MPEG4 or MPEG4-AVC.

28. The machine-readable storage according to claim 25, wherein said motion vectors histogram categorizes said received video data into one or more categories comprising extremely high motion content, high motion content, mid motion content, low motion content, and still motion content.

29. The machine-readable storage according to claim 25, wherein said detected type of said content of said received video data is one of interlaced type or progressive type.

30. The machine-readable storage according to claim 24, wherein said spatial filtering parameters comprises one or more of a current filtering cutoff parameter and a target filtering cutoff parameter.

31. The machine-readable storage according to claim 30, wherein said target filtering cutoff parameter provides an indication of said targeted bitrate.

32. The machine-readable storage according to claim 24, wherein said at least one code section comprises code for adaptively updating said spatial filtering parameters during an I frame of said received video data.

33. The machine-readable storage according to claim 23, wherein said at least one code section comprises code for encoding said received video data based on said adaptive updating of said one or more filtering parameters.
